(19) United States
(12) Patent Application Publication
(10) Pub. No.: US 2026/0168586 A1
(43) Pub. Date: Jun. 18, 2026

(54) COMPRESSED AIR DISCHARGE DEVICE FOR A PNEUMATIC SYSTEM FOR AN AIR SUSPENSION SYSTEM OF A MOTOR VEHICLE,AND COMPRESSED AIR SYSTEM

(71) Applicant: AUMOVIO Germany GmbH, Frankfurt am Main (DE)

(72) Inventor: Volkan Sirke, Hannover (DE)

(73) Assignee: AUMOVIO Germany GmbH, Frankfurt am Main (DE)

(21) Appl. No.: 19/422,766

(22) Filed: Dec. 17, 2025

(30) Foreign Application Priority Data
Dec. 17, 2024 (DE) 10 2024 212 028.6

(51) Int. Cl. F16K 17/04; B60G 11/27

(52) U.S. Cl. CPC F16K 17/0413; B60G 11/27; B60G 2202/152; B60G 2202/412; B60G 2202/42

(57) ABSTRACT

A compressed air discharge device for a pneumatic system for an air suspension system of a motor vehicle, comprising an inlet at which a first pneumatic pressure is applied, and an outlet. An elastically adjustable closing body is pneumatically arranged between the inlet and the outlet and configured to close or open a through opening on a counterpart on the side of the outlet, additionally comprising a passage opening which acts pneumatically parallel to the through opening and effectuates a pneumatic, in particular throttled, connection from the inlet to the outlet, wherein the closing body is adjustable such that the closing body presses against the counterpart below a predetermined pressure value of the first pneumatic pressure, such that the through opening is closed, and is lifted off from the counterpart above the predetermined pressure value of the first pneumatic pressure, such that the through opening is opened.

### CROSS REFERENCE TO RELATED APPLICATION

This application claims benefit of Patent Application No. 10 2024 212 028.6, filed Dec. 17, 2024, which is incorporated herein by reference in its entirety

### TECHNICAL FIELD

The embodiments relate to a compressed air discharge device for a pneumatic system for an air suspension system of a motor vehicle and to a compressed air system having such a compressed air discharge device.

### BACKGROUND

For the discharge of air from a compressed air system, for example, an air suspension system, the compressed air emerging generates a noise (loud bang), in particular if a high pressure prevails in the system. This acoustic negative effect is perceived as unpleasant and disturbing by the vehicle operator as well as the surroundings. It is therefore necessary to expediently dissipate the energy contained in the air flow and thus to ensure a slowed outflow from the compressed air system, which results in reduced acoustic effects.

A noise damping device for a compressed air compressor is known from DE 102 48 183 A1. The noise damping device is composed of a combined intake and discharge tract for the compressed air compressor, which comprises an air filter, a damping insert having a knitted roll, and an airflow throttle. The combination of these components or measures connected in series causes a reduction in airborne sound by 19 dB (A).

The muffler from DE 203 14 134 U1 comprises a wide variety of materials in the interior for reducing airborne noise, although this is associated with additional effort in the production and in the system of the absorbing material, wherein only a small reduction in airborne sound is achieved.

Another muffler is known from DE 101 21 582 A1. This muffler comprises a plurality of chambers connected in series, which are connected via channels to the adjacent chambers, wherein the cross sections of the channels expand in the outflow direction.

DE 100 04 880 A1 discloses the ventilation of a compressed air system via a variable throttle element which is arranged in a ventilating line. The throttle element automatically sets a free through-flow cross section of the ventilating line. It comprises a more or less restrictive slide, which is, on the one hand, spring-loaded and, on the other hand, has a control surface subjected to the pressure upstream of the throttle element. In the case of high pressure values upstream of the throttle element, the slide is moved by the pressure acting on said control surface against the force of the spring element into a position which relatively strongly restricts the free through-flow cross section, whereas, in the case of low pressure values upstream of the throttle element, this slide is moved by the force of the spring element into a practically non-throttling position, i.e., a position that more or less completely releases the through-flow cross section of the ventilating line. A throttle valve by means of which the line cross section is adjustable in an analogue manner is thus known.

### SUMMARY

It is an object to provide a compressed air discharge device for a pneumatically operating system, which causes improved noise damping when discharging compressed air, and is at the same time inexpensive and simply constructed.

### BRIEF DESCRIPTION OF THE DRAWINGS

In the Figures:

FIG. 1 shows a first exemplary compressed air discharge device in a closed switching position,

FIG. 2 shows the first exemplary compressed air discharge device in an open switching position,

FIG. 3 shows a second exemplary compressed air discharge device in a closed switching position,

FIG. 4 shows the second exemplary compressed air discharge device in a closed switching position,

FIG. 5 shows the closing body of the second exemplary compressed air discharge device in a top view, and

FIG. 6 shows an exemplary compressed air system having the exemplary compressed air discharge device.

### DETAILED DESCRIPTION

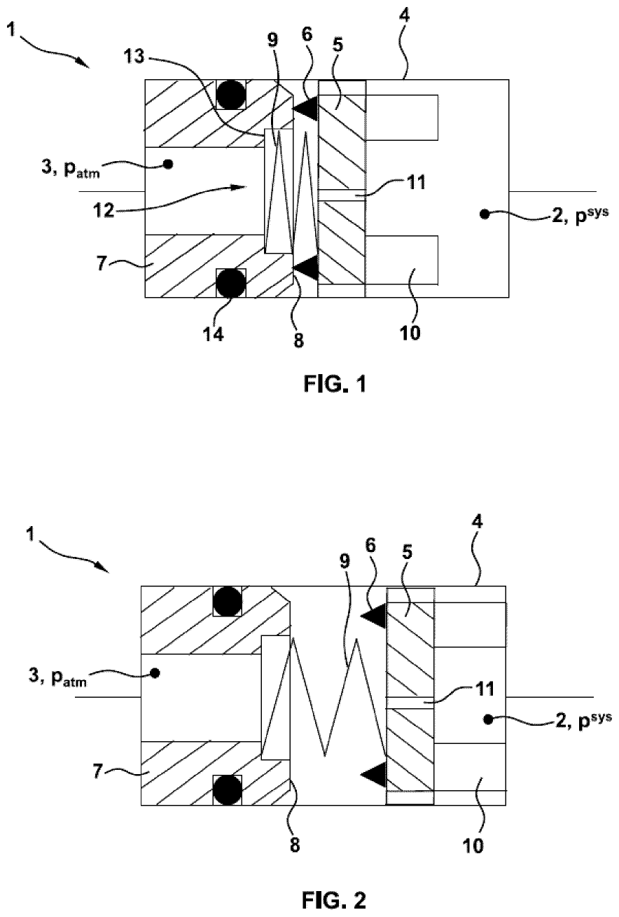

FIG. 1 shows a schematic illustration of a first exemplary compressed air discharge device 1 for a pneumatically operating system. The compressed air discharge device 1 may be used in an air suspension system of a motor vehicle. The compressed air discharge device 1 is used for noise damping when discharging compressed air from the pneumatic system. Here, the compressed air discharge device 1 comprises an inlet 2 at which a first pneumatic pressure p_{sys} is applied. This can be, for example, the system pressure of the pneumatic system or the pressure in a source of the system. On the other hand, the compressed air discharge device 1 comprises an outlet 2 at which a second pneumatic pressure pₐₜₘ is applied. This can be, for example, the atmospheric pressure, since compressed air is discharged from the system into the surroundings by means of the compressed air discharge device 1. It can, however, also be a further pneumatic system or another source of the system into which compressed air is transferred. Accordingly, according to the example, the second pneumatic pressure pₐₜₘ at the outlet 3 is lower than the first pneumatic pressure p_{sys} 2.

The compressed air discharge device 1 comprises a housing 4, within which a closing body 5 is movably arranged. Closing body 5 is configured to be pressed against a closing seat 8 of counterpart 7 in order to close a through opening 12 of the counterpart 7 there.

The housing 4 of the compressed air discharge device 1 can be a housing or housing section of a compressed air supply device. The compressed air discharge device 1 can be inserted into a line or a housing duct of the compressed air supply device which is used for the ventilation of the system supplied by means of the compressed air supply device. Here, counterpart 7 can also be designed as a hose connector which is plugged or screwed into the housing of the compressed air supply device. The hose connector then represents the closing seat 8. For sealing, the counterpart 7 comprises a sealing ring 14 in an outer-circumferential groove when it is inserted into a housing.

According to the example, the closing body 5 is acted on by means of a compression spring 9. The compression spring 9 is supported on a step 13 within the counterpart 7, and subjects the closing body 5 to a spring force which causes the closing body 5 to be lifted off from the closing seat 8. That is to say that the spring force of the compression spring 9 counteracts the first pneumatic pressure p_{sys} acting on the closing body 5 at the inlet 2.

In the position shown, the closing body 5 is in the pressurized state. The spring force of elastic compression spring 9 is adapted to a predetermined pressure value of the first pneumatic pressure p_{sys} at the inlet 2 such that, if the pressure force of the pneumatic pressure p_{sys} at the inlet 2 is greater than the spring force, the closing body 5 is pressed against the closing seat 8 of counterpart 7, such that through opening 12 is completely closed. In this way, there is no pneumatic connection from the inlet 2 to the outlet 3 via the large cross section of the through opening 12. For a pressure-tight closure of through opening 12 by means of closing body 5, a sealing means 6 is provided on the closing body. Sealing means 6 can alternatively also be arranged on the closing seat 8.

According to the example, the closing body 5 comprises a passage opening 11. The passage opening 11 is, for example, introduced centrally into the closing body 5. Alternatively, the passage opening 11 can also be introduced as a notch at a point in the closing seat 8 at which the closing body 5 comes into contact. The passage opening 11 is introduced into the closing body 5 from the inlet 2 in the direction of the outlet 3. The passage opening 11 has a smaller cross section in comparison to the through opening 12 on the counterpart 12. There can also be multiple passage openings in the closing body 5. When the through opening 12 is closed by the closing body 5, there is nevertheless a pneumatic connection from the inlet 2 to the outlet 3 by means of the passage opening 11. Accordingly, the passage opening 11 acts as a pneumatic throttle. When a first pneumatic pressure p_{sys} is applied, which closes the through opening 12 by means of the closing body 5, pressure is nevertheless dissipated from the system via the passage opening 11, albeit slowly. This prevents a loud bang upon the sudden pressure discharge.

FIG. 2 shows the compressed air discharge device 1 in the basic position, when no pressure is applied at the inlet 2 or when the first pneumatic pressure p_{sys} at the inlet 2 falls below the preset spring force of the compression spring 9. Thus, when the pressure has been adequately dissipated via the passage opening 11, the compression spring 9 allows the closing body 5 to lift off from the closing seat 8 and displaces the closing body away from the counterpart 7 within the housing. In this way, there is now a pneumatic connection from the inlet 2 to the outlet 3, which leads via the closing body 5 into the through opening 12. For this purpose, the closing body 5 is designed as substantially plate-shaped. The closing body 5 has a nominal diameter which is smaller than the diameter of the housing 4, so that compressed air can flow around the closing body 5 into the through opening 12. For centering and radial guidance, the closing body 5 also comprises a number of guide means 10. As a result, tilting of the closing body 5 within the housing 5 is prevented, and the closing body 5 is held centered within the housing 5.

The open switching position of closing body 5 enables faster pressure dissipation. However, the pneumatic pressure now acting on the closing body 5 has been lowered in advance in such a way that an unpleasant and loud bang noise is no longer produced. The pressure discharge from the compressed air system is thereby improved.

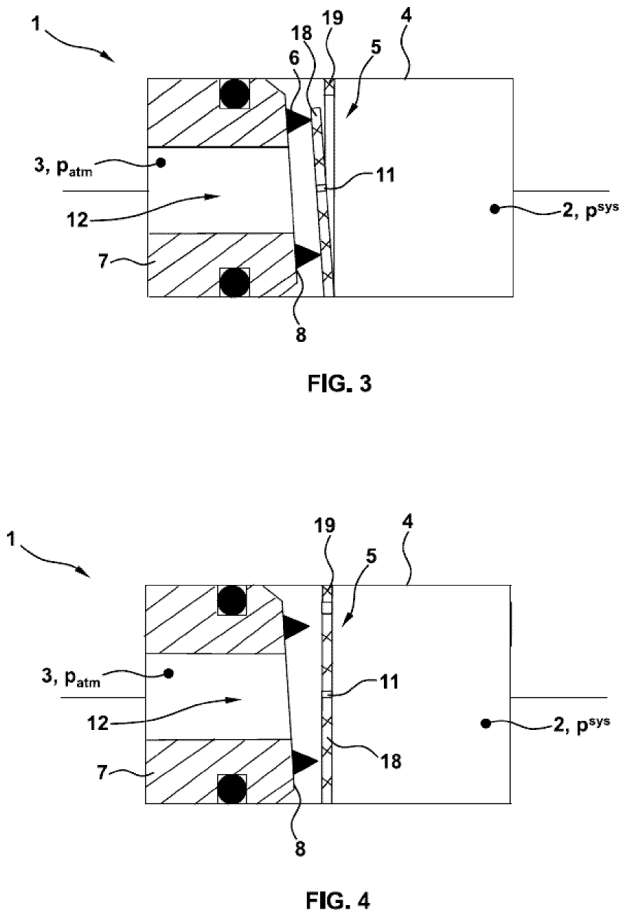

FIGS. 3 to 5 illustrate an alternative embodiment of a closing body 5. Thus, FIG. 3 shows a second exemplary compressed air discharge device 1, which functionally likewise brings about a throttled and damped pressure discharge like the first embodiment as in FIGS. 1 and 2. In this variant, the closing body 5 is embodied as a lamella body. The closing body 5 embodied as a lamella body can be manufactured from a metal (for example, sheet metal part) or also consist of an elastomeric material. The closing body 5 comprises an outer ring 19, by means of which it is held in the housing 4. A tongue 18, which is elastically displaceable, is formed in the interior. The tongue 18 is connected to the outer ring 19 in a thin transitional area and is otherwise spaced apart therefrom. The tongue 18 surrounds the passage opening 11. This may be introduced centrally into the tongue 18. Alternatively, the passage opening 11 can also be introduced as a notch at a point in the closing seat 8 at which the tongue 18 comes into contact. The passage opening 11 acts pneumatically as a throttle even when the through opening 12 is closed off by the tongue 18.

In this embodiment, counterpart 7 comprises a sealing means 6 on the valve seat 8. If the closing body 5 is embodied as an elastomer, no sealing means is required. The outer ring 19 and the tongue 18 are designed such that, when pressure is applied at the inlet 2 by the first pneumatic pressure p_{sys}, the tongue 18 is pressed elastically against the closing seat, such that the through opening 12 thereof is closed.

The spring elasticity of the tongue 18 or the closing body 5 in the area where the tongue 18 merges into the outer ring 19 is set to a pressure value of the first pneumatic pressure p_{sys} at the inlet 2, which presses the tongue 18 against the closing seat 8.

Accordingly, the closing body 5 is located having its tongue 18 in a basic position if the pressure value of the first pneumatic pressure p_{sys} at the inlet 2 is lower than the spring elasticity. This is shown in FIG. 4. In this position, the through opening 12 is open and the compressed air can flow over the closing body 5 between the outer ring 19 and the tongue 18.

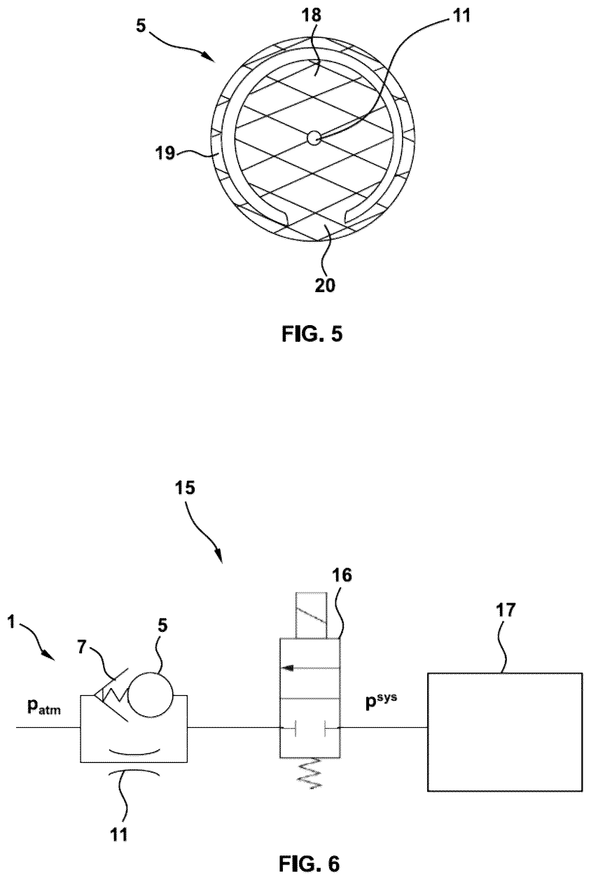

For better illustration, FIG. 5 also shows the closing body 5 embodied as a lamella body in a top view. The outer ring 19 and the inner elastic tongue 18 can be seen. The tongue 18 is spaced apart from the outer ring 19 in the shape of an almost closed U. This shape can be created, for example, by stamping. The tongue 18 and the outer ring 19 are connected to one another only in one connecting area. The spring elasticity of closing body 5 acts here. Furthermore, the centrally introduced passage opening 11 is also visible.

Finally, the use of exemplary pressure discharge device 1 in a compressed air system 15 is also shown. The pressure discharge device 1 is thus arranged in a discharge line of the pneumatic system in order to dissipate the pressure p_{sys} of a pressure source 17 into the atmosphere pₐₜₘ. The pressure source can be, for example, an entire compressed air system, such as an air suspension system of a motor vehicle, or also an air spring or a pressure accumulator.

A switching valve 16 is connected upstream of the pressure discharge device 1 to ensure that the compressed air does not escape in an uncontrolled manner from pressure source 17 into the surroundings. The switching valve 16 can be actuatable pneumatically or electromagnetically. Accordingly, to discharge pressure from the compressed air system, switching valve 16 is opened. In this way, the pressure discharge device 1 in the basic position is subjected on the inlet side to the pressure p_{sys} from the pressure source 17. If this pressure is higher than the elastic restoring force of the closing body 5, the closing body 5 is pressed, counter to the elastic spring force, against the counterpart 7, by which the through opening 12 thereof is closed. Only the passage opening 11 acting as a throttle is pneumatically active for the discharge of compressed air into the surroundings. As a result of the exemplary pressure relief device 1, the opening of switching valve 16 under high pressure does not produce a loud bang because the applied pressure is initially released in a throttled manner. As soon as the pressure p_{sys} falls below the predefined spring force of the closing body 5, the through opening 12 immediately opens completely. In this way, the entire cross section of the through opening 12 is immediately available for the discharge of compressed air. Due to the pressure that has already been partially dissipated, there is no longer a loud bang noise that is perceived as unpleasant. However, a larger volume of air can now be discharged in a shorter time through the open through opening 12.

1. A compressed air discharge device for a pneumatic system for an air suspension system of a motor vehicle, comprising:
an inlet at which a first pneumatic pressure is applied;
an outlet;
an elastically adjustable closing body is pneumatically arranged between the inlet and the outlet configured to close or open a through opening on a counterpart on the side of the outlet, additionally comprising a passage opening which acts pneumatically parallel to the through opening and effectuates a pneumatic, throttled, connection from the inlet to the outlet;
wherein the closing body is adjustable such that the closing body presses against the counterpart above a predetermined pressure value of the first pneumatic pressure, such that the through opening is closed, and is lifted off from the counterpart above the predetermined pressure value of the first pneumatic pressure, such that the through opening is open.

2. The compressed air discharge device as claimed in claim 1, wherein a cross section of the passage opening is smaller than a cross section of the through opening.

3. The compressed air discharge device as claimed in claim 1, wherein a second pneumatic pressure is applied at the outlet, wherein the first pneumatic pressure is greater than the second pneumatic pressure.

4. The compressed air discharge device as claimed in claim 1, wherein the closing body is adjustable by an elastic opening means, the opening force of which counteracts the first pneumatic pressure at the inlet.

5. The compressed air discharge device as claimed in claim 4, wherein the opening means is a compression spring.

6. The compressed air discharge device as claimed in claim 5, wherein the compression spring presses against the counterpart on the one hand and acts on the closing body on the other hand.

7. The compressed air discharge device as claimed in claim 5, wherein the spring force of the compression spring is set to the predetermined pressure value of the first pneumatic pressure.

8. The compressed air discharge device as claimed in claim 1, wherein the closing body comprises an elastic means, the elasticity of which counteracts the first pneumatic pressure at the inlet.

9. The compressed air discharge device as claimed in claim 8, wherein the elastic means is embodied as a flexible tongue, which is configured to close the through opening on the counterpart.

10. The compressed air discharge device as claimed in claim 9, wherein the elasticity of the tongue is set to the predetermined pressure value of the first pneumatic pressure.

11. The compressed air discharge device as claimed in claim 1, wherein the passage opening is introduced into the closing body.

12. The compressed air discharge device as claimed in claim 1, wherein a sealing means is attached to the counterpart or to the closing body.

13. A compressed air system comprising:
a compressed air discharge device comprising:
an inlet at which a first pneumatic pressure is applied;
an outlet;
an elastically adjustable closing body is pneumatically arranged between the inlet and the outlet configured to close or open a through opening on a counterpart on the side of the outlet, additionally comprising a passage opening which acts pneumatically parallel to the through opening and effectuates a pneumatic, throttled, connection from the inlet to the outlet;
wherein the closing body is adjustable such that the closing body presses against the counterpart above a predetermined pressure value of the first pneumatic pressure, such that the through opening is closed, and is lifted off from the counterpart below the predetermined pressure value of the first pneumatic pressure, such that the through opening is open;
a compressed air source, which delivers the first pneumatic pressure; and
a normally closed switching valve pneumatically arranged between the compressed air discharge device and the compressed air source.

14. The compressed air system as claimed in claim 13, wherein the switching valve is electromagnetically or pneumatically actuatable.

15. The compressed air system as claimed in claim 13, wherein the compressed air discharge device is introduced into a discharge tract of the compressed air system.
